(19) United States
(12) Patent Application Publication
(10) Pub. No.: US 2001/0046294 A1
(43) Pub. Date: Nov. 29, 2001

(54) Method of and system for counterfeit prevention

(76) Inventors: William R. Bandy, Gambrills, MD (US); Michael R. Arneson, Westminster, MD (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/780,573

(22) Filed: Feb. 12, 2001

Related U.S. Application Data
(60) Provisional application No. 60/181,932, filed on Feb. 11, 2000.

(51) Int. Cl. H04L 9/32

(52) U.S. Cl. 380/51; 713/179

(57) ABSTRACT

Counterfeit resistant articles are created by reading a first pattern from an article and encoding the first pattern into a first data set. The first data set is transformed into a second data set, and converted into a second pattern. An article is marked with the second pattern to make it counterfeit resistant. Identification of counterfeit articles occurs by reading a plurality of patterns and converting the plurality of patterns into a corresponding plurality of data sets. These corresponding data sets are then compared for counterfeit identification purposes.

### CROSS-REFERENCE TO RELATED APPLICATION

This patent application claims priority to and is entitled to the benefit of Provisional Patent Application No. 60/181,932, filed Feb. 11, 2000 entitled “Method of and System for Counterfeit Prevention.” This provisional application is incorporated herein by reference in its entirety.

### BACKGROUND OF THE INVENTION

1. Field of the Invention

The present invention relates generally to the marking of articles. More particularly, the present invention pertains to detection and prevention of counterfeiting.

2. Background Art

Counterfeiting is a problem for manufacturers, distributors, and retailers. Tangible articles such as apparel, video cassettes, books, golf clubs and other products are often counterfeited. Counterfeiting deprives revenue from legitimate businesses and individuals. Also, counterfeit articles are often inferior in quality. Thus, counterfeiting frequently damages the reputations of manufacturers, wholesalers, and retailers. What is needed is a technique for detecting counterfeit products.

### BRIEF SUMMARY OF THE INVENTION

The present invention is directed at techniques for making articles counterfeit resistant and effectively identifying counterfeit articles. These techniques involve uniquely marking articles. A feature of the present invention involves marking articles with visible and invisible patterns. The markings made in accordance with the present invention are difficult to identify and replicate. As a result of this difficulty, it becomes virtually impossible to produce counterfeit articles that can readily pass as genuine articles.

Another feature of the invention provides the ability to distinguish counterfeit articles from genuine articles. This ability involves the comparison of data based on visible and invisible patterns. As a result of this feature, merchants and businesses are able to restrict the flow of commerce in counterfeit articles.

According to an embodiment of the present invention, counterfeit resistant articles are created by reading a first pattern from an article and encoding the first pattern into a first data set. The first data set is transformed into a second data set, and converted into a second pattern. An article is marked with the second pattern to make it counterfeit resistant.

According to another embodiment of the present invention, counterfeit articles are identified by reading a plurality of patterns and converting the plurality of patterns into a corresponding plurality of data sets. These corresponding data sets are then compared for counterfeit identification purposes.

According to a further embodiment of the present invention, a distributed counterfeit and prevention monitoring system includes a network, a marking node connected to the network, a verification node connected to the network, and a security management node connected to the network.

### BRIEF DESCRIPTION OF THE FIGURES

The present invention will be described with reference to the accompanying figures.

FIG. 1 illustrates a first counterfeit resistant article 100 marked according to a preferred embodiment of the present invention;

FIG. 2 illustrates a second counterfeit resistant article 200 marked according to a further embodiment of the present invention;

FIG. 3 illustrates a distributed counterfeit and prevention monitoring system;

FIG. 4 illustrates a marking node according to a preferred embodiment of the present invention;

FIG. 5 illustrates a verification node according to a preferred embodiment of the present invention;

FIG. 6 illustrates a security management node according to a preferred embodiment of the present invention;

FIG. 7 illustrates a technique of marking articles with two complementary patterns;

FIG. 8 illustrates using a preexisting pattern on an article to mark a single pattern on an article; and

FIG. 9 illustrates a counterfeit detection process according to an embodiment of the present invention.

### DETALED DESCRIPTION OF THE INVENTION

An article can be any tangible object. Examples of articles include clothing, credit cards, books, video tapes, compact discs, and most consumer goods. The techniques used in the present invention involve markings. A marking is any pattern on a particular article that is used to identify or gather information about an article. Examples of conventional markings include symbols such as bar codes and printed characters. Bar codes include one-dimensional and two dimensional patterns. Printed characters include numbers, such as serial numbers and lot numbers, and text. Markings also include other patterns, such as holograms on credit cards. Markings according to the present invention are any patterns that carry information.

The placing of unique markings on an article is a key concept of the present invention. Unique markings enable techniques for determining whether individual articles are genuine or counterfeit. Unique markings also enable the tracking of individual articles.

Markings can be deterministic or random. An example of a deterministic marking is the printing of lot and serial numbers on a manufactured article according to a predetermined scheme. Markings that result from a deterministic process are typically symbols such as text and bar codes.

Markings can also be random. Like deterministic markings, random markings can be symbols such as text and bar codes. However, the information that these symbols represent do not arise from a predetermined scheme. Random markings can also include a given article's inherent qualities such its coloration and texture.

Markings can be either visible or invisible. Conventional markings, such as bar codes and serial numbers, are typically visible. These markings are often printed on articles with ink or dye. Invisible markings can be made through the use of substances such as phosphorescent particles that radiate outside of the visible light spectrum. When phosphorescent particles are stimulated with visible light, they radiate in the infrared spectrum. Phosphorescent particles that are very small can be readily obtained. For example, phosphorescent particles in the form of beads are currently available in sizes as small as 3-5 microns in diameter.

A material that radiates outside of the visible light spectrum can be applied to an article to create unique markings that are not discernable to the human eye. For example, small phosphorescent particles could be mixed with paint, dye, ink, or any other substance. Application of such a mixture to an article would create a random pattern of phosphorescent particles on an article. Phosphorescent particles could also be applied to threads or fibers that are woven into an article containing fabric.

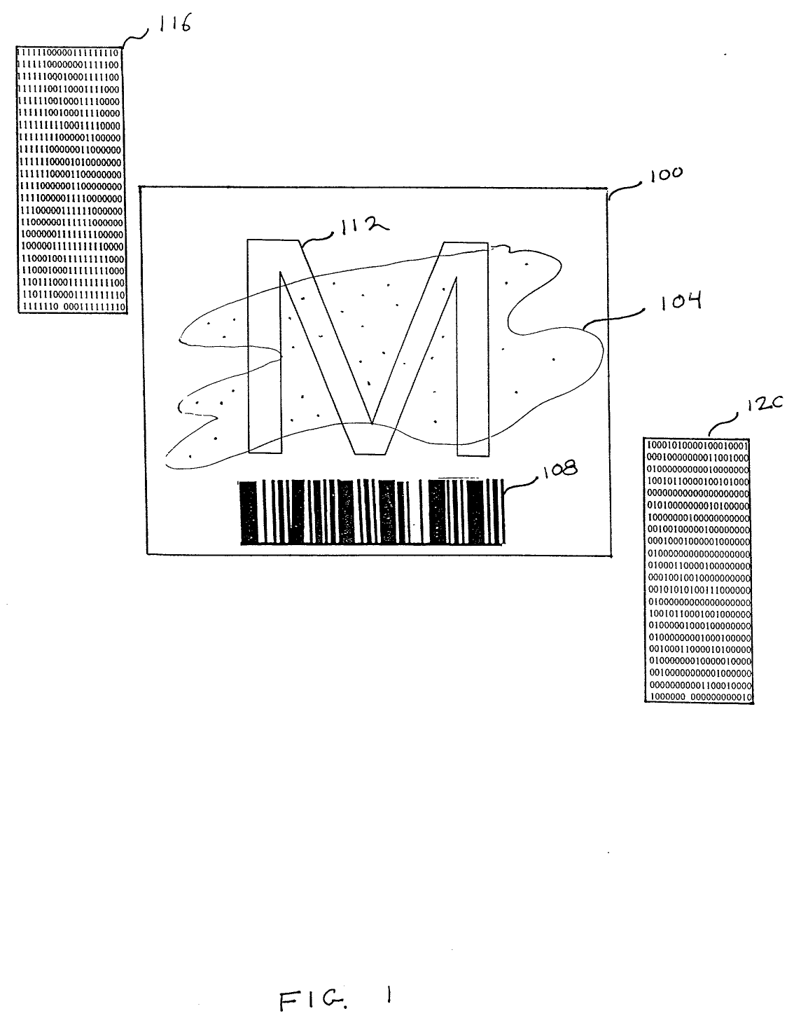

FIG. 1 illustrates a first counterfeit resistant article 100 marked according to a preferred embodiment of the present invention. First counterfeit resistant article 100 comprises a latent marking 104, a complementary marking 108, and a framing image 112. In addition, FIG. 1 also illustrates baseline data set 116 and complementary data set 120. Baseline data set 116 and complementary data set 120 are associated with latent marking 104 and complementary marking 108, respectively.

First counterfeit resistant article 100 is any tangible object that has a surface suitable to support markings. Examples of first counterfeit resistant articles 100 include fabric, clothing labels, price tags, paper documents, credit cards, ATM cards, debit cards, and surfaces on consumer goods such as book covers.

In a preferred embodiment, latent marking 104 is a random scattering of phosphorescent particles. These particles can be applied to first counterfeit resistant article 100 according to the techniques described above or by any other technique known to persons skilled in the relevant arts. In alternate embodiments, latent marking 104 is any visible or invisible pattern. These markings can be an inherent article property, or can be applied by a separate marking process. Baseline data set 116 is data generated by decoding latent marking 104. In a preferred embodiment, baseline data set 116 is a numeric sequence. However, in alternate embodiments, baseline data set 116 can be data in any form.

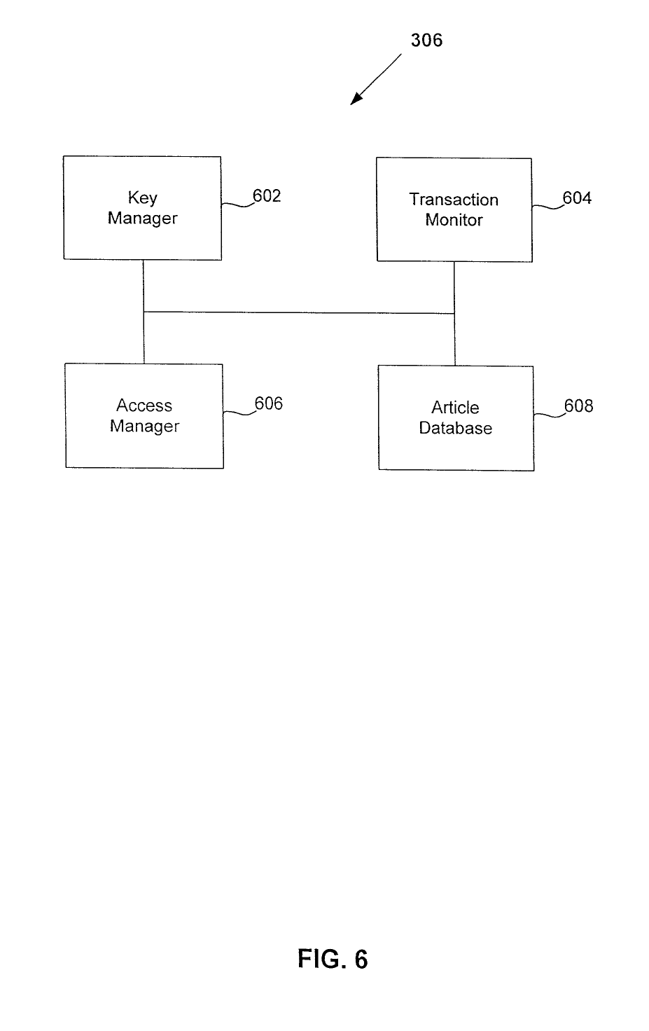

Framing image 112 is a pattern that exists on first counterfeit resistant article 100. In a preferred embodiment, framing image 112 is visible. Framing image 112 establishes a frame of reference for reading and decoding latent marking 104. In a preferred embodiment, this frame of reference includes rotation and translation in a rectangular coordinate system. Establishing a proper frame of reference provides a grid framework suitable for converting latent marking 104 into an image signal that can be decoded into baseline data set 116. A reading and decoding method according to a preferred embodiment is described with respect FIG. 6 below.

To uniformly establish frames of reference across a plurality of articles, framing image 112 is a pattern that exists on all articles of a certain class. A class of articles contains a group of articles that are likely to be examined together. An example of a class of articles is apparel manufactured by a certain designer. In this example, the designer's logo is printed on a label attached to each article of apparel the designer manufactures. Since this logo exists on all articles produced by the designer, it can be used as a framing image 112.

In a preferred embodiment, complementary marking 108 is a bar code. Complementary marking 108 represents complementary data set 120 according to any bar code conventions known to persons skilled in the relevant arts. In alternate embodiments, complementary marking 108 is any pattern that can be read and decoded into data. Examples of such markings include text characters, magnetic strips, and other markings capable of being read and decoded into data that are well known to persons skilled in the relevant arts.

Complementary data set 120 corresponds to baseline data set 116 according to a defined relationship. In a preferred embodiment, this defined relationship is governed by an encryption algorithm. In alternate embodiments, this relationship can be any defined algorithm, or mapping.

Encryption involves the protection of information. A typical encryption algorithm converts a first set of unencrypted or plain text data into a second set of encrypted or cipher text data. These sets of data are often handled by encryption algorithms as numeric sequences. The execution of an encryption algorithm results in the existence of two sets of complementary data: the original unencrypted set and the generated encrypted set. A precise relationship exists between these two data sets. This relationship is defined by the encryption algorithm and the encryption key used during the encryption process.

Encryption keys are information analogous to passwords. They contribute in forming the relationship between unencrypted data and encrypted data. Decryption is the process of using an encryption algorithm to convert an encrypted data set back into its unencrypted original form. In Symmetric encryption algorithms, the same key is used to encrypt and decrypt data. Asymmetric, or public-key encryption uses one key to encrypt data and another key to decrypt the encrypted data.

Without possession of the proper algorithm and keys, it is very difficult to compromise an encryption scheme. Encryption techniques and algorithms are well known to persons skilled in the relevant arts and can be implemented through hardware, software, firmware, or any combination thereof.

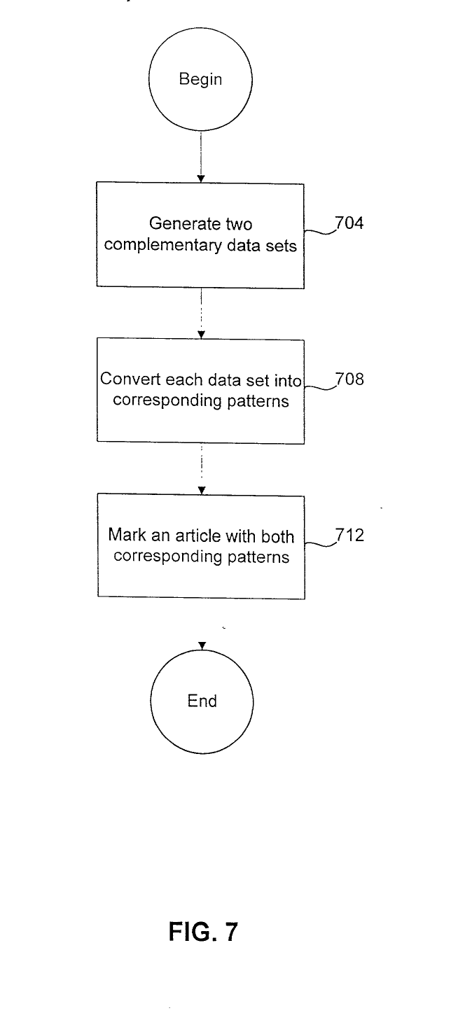

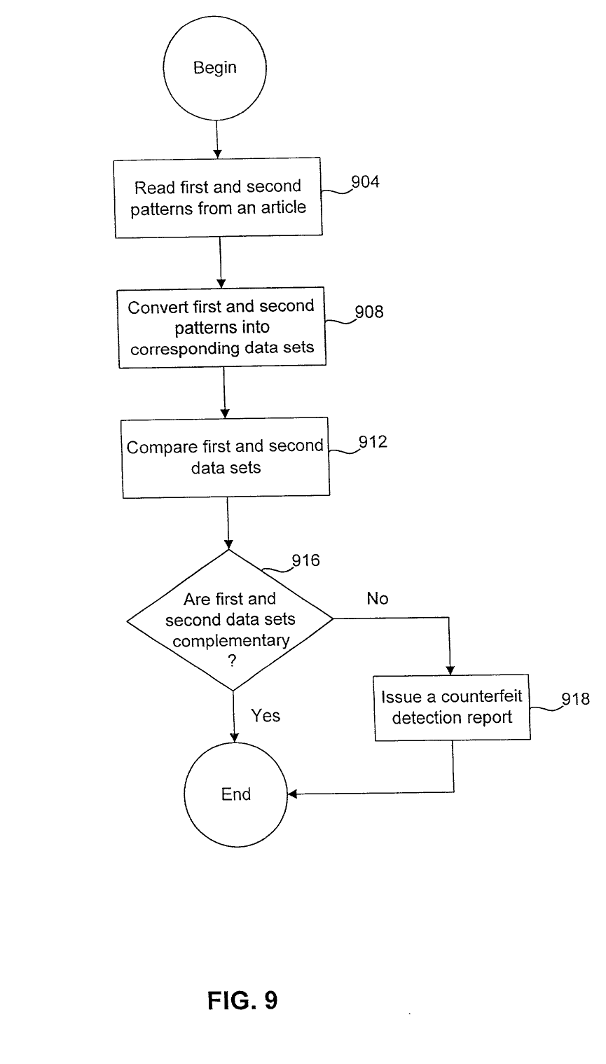

The verification of an article as a genuine first counterfeit resistant article 100 is performed by comparing baseline data set 116 with complementary data set 120. Obtaining these data sets according to a preferred embodiment is described below with respect to FIG. 7. In a preferred embodiment where data sets are related according to an encryption algorithm, the comparison of these data sets is performed by choosing either baseline data set 116 or complementary data set 120 and applying the chosen data set to an encryption algorithm. The encryption algorithm outputs a new data set. If the new data set matches the data set not chosen, then baseline data set 116 and complementary data set 120 properly correspond to each other. In this case, the article is verified as a genuine article. If the new data set fails to match the data set not chosen, then a counterfeited article has been identified. The application of this comparison process will be described further with respect to FIG. 9.

First counterfeit resistant article 100 hinders counterfeiting because the relationship between latent marking 104 and complementary marking 108 is difficult to identify and reproduce. In a preferred embodiment, where the relationship between these markings is based on an encryption algorithm, the chances of identifying and replicating the relationship become infinitesimal.

In addition, the characteristics of latent marking 104 further hinder counterfeiting. Counterfeiters desiring to copy only a single article will have to reproduce both latent marking 104 and complementary marking 108. As discussed above, in a preferred embodiment, latent marking 104 is a random scattering of phosphorescent particles. Since these particles are invisible, very small, and randomly scattered, the duplication of latent marking 104 is extremely difficult. Therefore, counterfeiting a single article as described with respect to FIG. 1 presents a severe challenge.

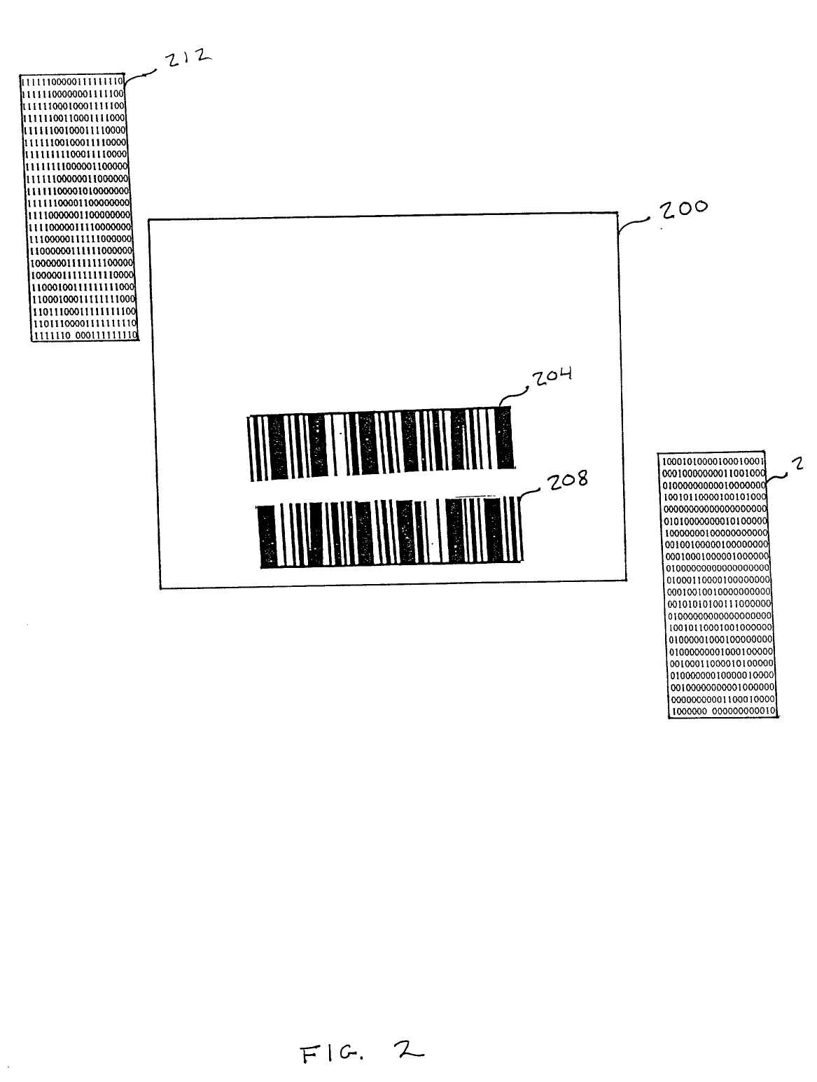

FIG. 2 illustrates a second counterfeit resistant article 200 marked according to a further embodiment of the present invention. Second counterfeit resistant article 200 comprises a first visible marking 204 and a second visible marking 208. Also illustrated are first data set 212 and second data set 216.

In a preferred embodiment, first visible marking 204 and second visible marking 208 are both bar codes. In alternate embodiments, first visible marking 204 and second visible marking 208 are any patterns that can be read and decoded into data. Examples of such markings include text characters, magnetic strips, and other markings well known to persons skilled in the relevant arts.

First data set 212 and second data set 216 represent first visible marking 204 and second visible marking 208, respectively. Similar to the embodiment described with respect to FIG. 1, first data set 212 corresponds to second data set 216 according to a defined relationship. In a preferred embodiment, this relationship is defined by an encryption algorithm.

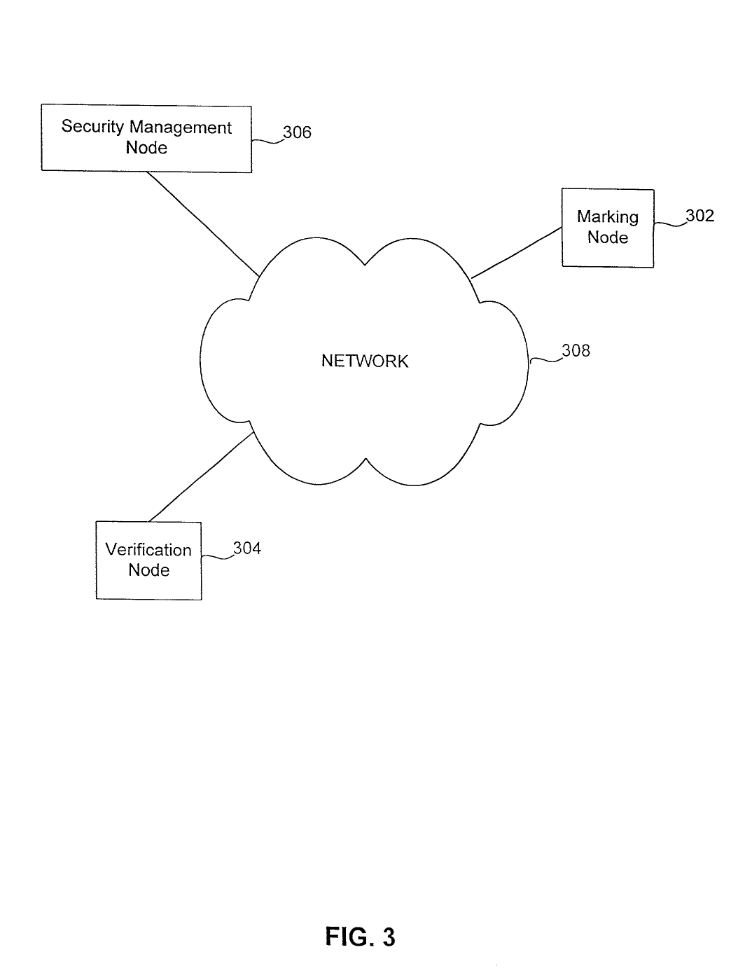

FIG. 3 is an illustration of a distributed counterfeit and prevention monitoring system. This system includes a marking node 302, a verification node 304, and a security management node 306. These nodes are all connected to a network 308. In a preferred embodiment, network 308 is capable of providing secure and reliable data communications. Embodiments of the present invention include any number of these nodes connected to network 308 in any combination.

Marking node 302 places markings on articles to make them counterfeit resistant. In a preferred embodiment, these markings create first counterfeit resistant articles 100 and second counterfeit resistant articles 200. Verification node 304 interprets markings on articles and determines whether or not articles are genuine or counterfeit. If verification node 304 identifies a counterfeit article, it issues a counterfeit detection report.

Security management node 306 monitors events reported by marking node 302 and verification node 304. Security management node 306 also manages security data such as encryption keys. In addition, security management node 306 maintains article databases and performs registration functions for marking nodes 302 and verification nodes 304.

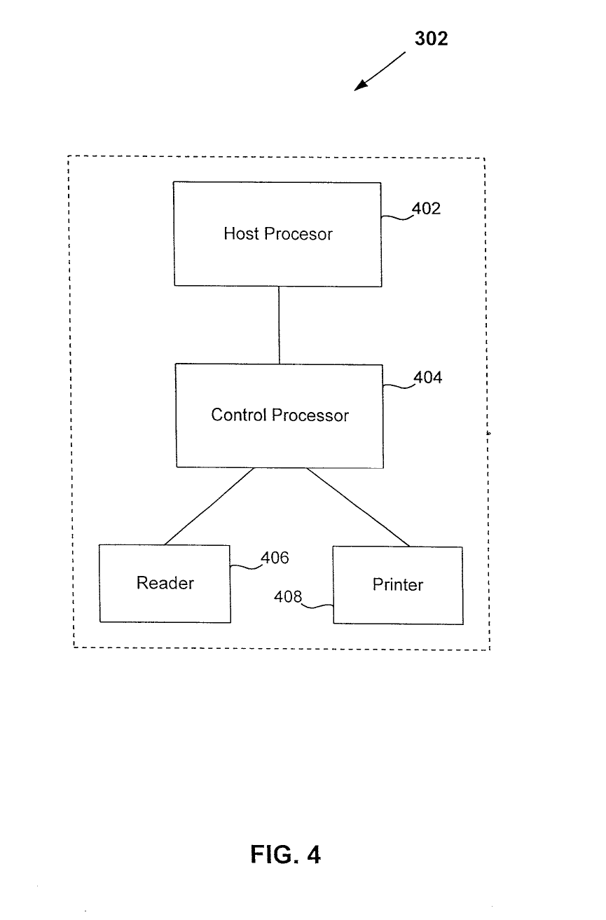

FIG. 4 illustrates a marking node 302 according to a preferred embodiment. Marking node 302 includes a marking host processor 402, a marking control processor 404, a reader 406, and a printer 408.

Marking host processor 402, in a preferred embodiment, is a personal computer. In alternate embodiments, marking host processor 402 could be an inventory management system, a retail system such as a point of sale (POS) terminal, a cash register, or any processing device. Marking host processor 402 enables users to interface with marking node 402. Marking host processor also stores information regarding marking activity, articles, and security data.

In a preferred embodiment, marking control processor 404 is a PCMCIA peripheral card that connects to marking host processor 402. Marking control processor 404 performs processing tasks necessary to mark articles in a counterfeit-resistant way. These processing tasks include encryption, image processing, communication with marking host processor 402, and the control of other marking node 302 components such as reader 406 and printer 408.

Reader 406 reads markings from articles. Marking control processor 404 and reader 406 collaborate to translate markings into corresponding data sets. Reader 406 is a handheld device that includes one or more optical scanners. In addition, reader 406 contains processing capabilities necessary to read markings, interact with users, and communicate with marking control processor 404. These processing capabilities can be implemented through hardware, software, firmware, or any combination thereof.

In a preferred embodiment, reader 406 can read first counterfeit resistant articles 100 and second counterfeit resistant articles 200. Therefore, reader 406 is capable of reading both bar codes and infrared patterns. In alternate embodiments, reader 406 is capable of reading other markings such as magnetic strips and text. Reader 406 includes one or more optical scanners that are implemented with charge-coupled devices (CCDs). CCDs are solid-state chips that turn light into electrical signals. CCDs can be adapted to operate with various portions of the light spectrum such as the visible and infrared portions. CCDs are arranged into a grid of elements. Each grid element corresponds to an image pixel. When exposed to an image, each grid element stores an electric charge. These electric charges are ultimately quantized into digital pulses by reader 406. Marking control processor translates these digital pulses into a corresponding data set using image processing techniques well known to persons skilled in the relevant arts.

Printer 408 prints patterns on articles. In a preferred embodiment, printer 408 is a laser printer capable of printing bar codes and using ink containing phosphorescent particles. However, examples of printer 408 include lithographic printers, silk screen printers, as well as any type of printing device. Printer 408 is connected to marking control processor 404. Marking control processor 404 translates data sets into directives. These directives are sent to printer 408. Printer 408 responds to these directives by printing corresponding markings on articles so that they conform to either first counterfeit resistant article 100 or second counterfeit resistant article 200.

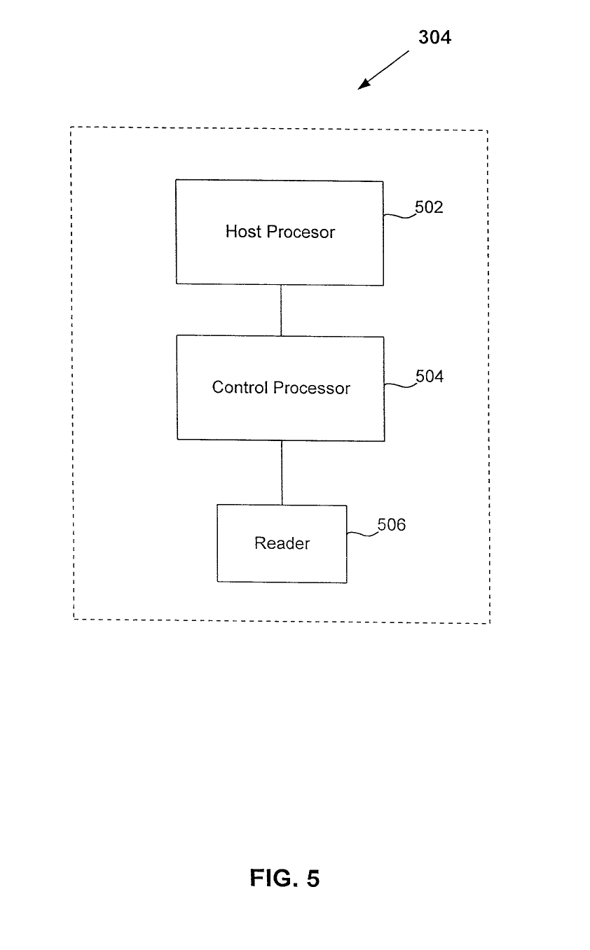

FIG. 5 illustrates a verification node 304 according to a preferred embodiment. Verification node 304 is very similar in structure to marking node 302. Verification node 304 includes a verification host processor 502, a verification control processor 504, and a reader 506.

Verification host processor 502, in a preferred embodiment, is a personal computer. In alternate embodiments, verification host processor 502 could be an inventory management system, a retail system such as a point of sale (POS) terminal, a cash register, or any processing device. Verification host processor 502 enables users to interface with verification node 304. Verification host processor 502 also stores information regarding verification activity, articles, and security data.

In a preferred embodiment, verification control processor 504 is a PCMCIA peripheral card that connects to verification host processor 502. Verification control processor 504 performs processing tasks necessary to verify the authenticity of articles. These processing tasks include encryption, image processing, communication with verification host processor 502, and the control of other verification node 304 components such as reader 506 and printer 508.

Reader 506 reads markings from articles. Verification control processor 504 and reader 506 collaborate to translate markings into corresponding data sets. Reader 506 is a handheld device that includes one or more optical scanners. In addition, reader 506 contains processing capabilities necessary to read markings, interact with users, and communicate with verification control processor 504. These processing capabilities can be implemented through hardware, software, firmware, or any combination thereof.

In a preferred embodiment, reader 506 reads latent markings 304 from first counterfeit resistant articles 100. Therefore, reader 506 is capable of reading infrared patterns. Reader 506 includes one or more optical scanners that are implemented with charge-coupled devices (CCDs). In alternate embodiments, reader 506 is capable of reading other markings such as bar codes, magnetic strips and text.

FIG. 6 illustrates components of a security management node 306 according to a preferred embodiment. Security management node 106 includes a key manager 602, a transaction manager 604, an access manager 606, and an article database 608. These components can be implemented with hardware, software, firmware, or any combination thereof.

Key manager 602 maintains encryption keys and other security information. These keys are distributed to marking nodes 302 and verification nodes 304 via network 308. Key manager 602 also periodically updates encryption keys used by these nodes to mark and verify articles. Updating encryption keys minimizes the threat of a security compromise and frustrates the efforts of potential counterfeiters.

Transaction manager 604 records marking and verification events. These events occur at marking nodes 302 and verification nodes 304, respectively. Recording these events helps track the distribution of articles throughout various geographic locations.

Access manager 606 controls access by marking nodes 302 and verification nodes 304. In particular, access manager can grant or deny to any node membership in distributed counterfeit prevention and monitoring system 300. Nodes having membership in distributed counterfeit prevention and monitoring system 300 have access to security information controlled by key manager 602. Therefore, membership is a prerequisite for the appropriate marking and verification of articles.

Article database 608 maintains records for every article marked according to the present invention. In an embodiment of the present invention, article database 608 can analyze its records to verify whether successful counterfeiters have been able to duplicate a given set of articles. If this occurs, article database will identify duplicate articles. This will prompt key manager 602 to issue new encryption information to thwart the efforts of counterfeiters.

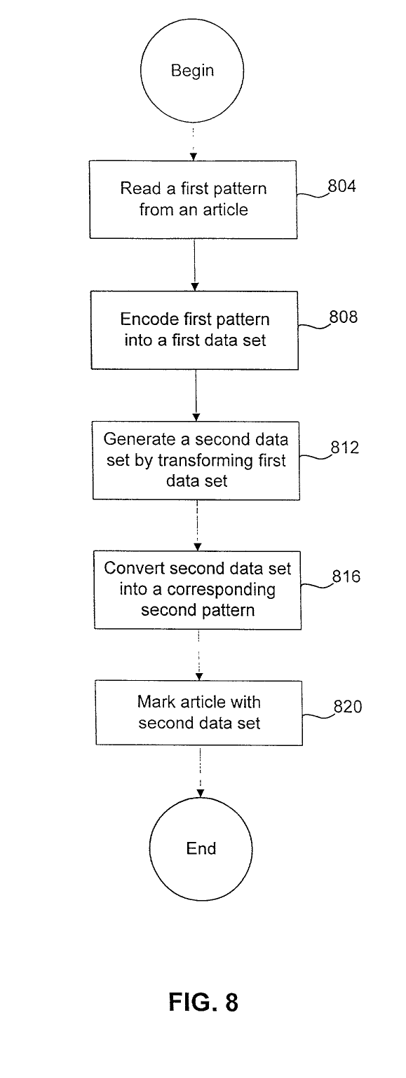

As stated above, the present invention involves techniques of marking articles to make them counterfeit resistant. The present invention also involves techniques for reading articles and determining whether or not they are counterfeit. FIGS. 7 and 8 illustrate two techniques to mark articles in a manner that makes them counterfeit resistant in accordance with the present invention.

FIG. 7 illustrates the generation of a second counterfeit resistant article 200. This process is performed by marking node 302 and begins with step 704. In step 704, marking control processor 404 generates two complementary data sets. In a preferred embodiment of the present invention, this step is performed through generating an original data set and then using an encryption algorithm and an encryption key to generate complementary data set. These data sets are first data set 212 and second data set 216. This original data set could be generated by a random number generator in marking control processor 404. Also, this original data set could be generated according to some deterministic scheme. Examples of data sets generated through deterministic schemes are serial numbers, lot numbers, calendar dates, times, and persons who manufactured the article.

In step 708, marking control processor 404 converts each of the two data sets into corresponding patterns. These corresponding patterns are first visible marking 204 and second visible marking 208. In a preferred embodiment, these patterns are bar codes. However, in other embodiments, these markings could be digits, or any pattern that carries information. Next, in step 712, printer 408 marks an article with first visible marking 204 and second visible marking 208.

Since first visible marking 204 and second visible marking 208 are visible, replication of second counterfeit resistant article 200 is foreseeable. However, if a counterfeiter wishes to make multiple counterfeit articles, the counterfeiter would have to use a variety of patterns to not be obvious. When producing more than one counterfeit article without possession of the apppropriate encryption algorithm and key, a counterfeiter would not be able to generate articles with unique patterns that are complementary. Therefore, detection of counterfeit articles would occur early and the counterfeiter's efforts would be frustrated.

FIG. 8 illustrates the use of a preexisting latent pattern on an article to generate a first counterfeit resistant article 100. This process is performed by marking node 302 and begins with step 804.

In step 804, reader 406 reads a first pattern from an article. This pattern is latent marking 104. In a preferred embodiment, latent marking 104 is a random scattering of invisible phosphorescent particles. To read latent marking 104, reader 406 and marking control processor 404 must first acquire and read framing image 112. As described above, framing image 112 establishes a frame of reference for reading and decoding latent marking 104. In a preferred embodiment, this frame of reference is a rectangular coordinate system. Once a frame of reference is established, reader 406 maps an infra red image generated by latent marking 104 into a grid based from the established frame of reference. This mapping results in an latent image signal.

In step 808, marking control processor 404 encodes the latent image signal generated by step 804 into baseline data set 116. In a preferred embodiment, baseline data set 116 is a numeric sequence. Next, in step 812, marking control processor 404 generates a complementary data set 120 by transforming baseline data set 116. In a preferred embodiment, this transformation is performed through the use of an encryption algorithm and an encryption key.

Next, in step 816, marking control processor 404 converts complementary data set 120 into complementary marking 108. In a preferred embodiment, complementary marking 108 is a bar code printed in the visible light spectrum. However, in alternate embodiments, complementary marking 108 is any pattern that carries information. Finally, in step 820, printer 408 marks an article with complementary marking 108. The completion of step 820 culminates in the existence of a first counterfeit resistant article 100.

FIG. 9 illustrates a counterfeit detection process according to an embodiment of the present invention. In a preferred embodiment, this process is performed by verification node 104 and begins with step 904. This process will be described with respect to both first counterfeit resistant article 100 and second counterfeit resistant article 200.

In step 904, reader 506 reads two patterns from an article subject to verification. In a preferred embodiment, this article can be marked in accordance with either first counterfeit resistant article 100 or second counterfeit resistant article 200. In the case of first counterfeit resistant article 100, these markings are latent marking 104 and complementary marking 108. As described above with respect to step 804, when latent marking 104 is a random scattering of phosphorescent particles, framing image 112 is first acquired to establish a frame of reference. Reader 506 acquires this image and, with verification control processor 504, establishes a frame of reference. Reader 506 and verification control processor 504 then use the frame of reference to generate an image signal that corresponds to latent marking 104. In a preferred embodiment, complementary marking 108 is a visible bar code. Reader 506 reads complementary marking 108 and converts it into a signal.

In the case of second counterfeit resistant article 200, these patterns are first visible marking 204 and second visible marking 208. In a preferred embodiment, both of these markings are visible bar codes. Reader 306 reads these patterns and converts them into signals.

In step 908, verification control processor 504 converts the signals generated in step 904 into complementary data sets. In the case of first counterfeit resistant article 100, these data sets are baseline data set 116 and complementary data set 120. However, in the case of second counterfeit resistant article 200, these data sets are first data set 212 and second data set 216.

Next, step 912 is performed. In step 912, verification control processor compares the two data sets produced by step 910. This comparison is performed according to a relationship contained in verification control processor 504. Control processor 504 may have received this relationship through verification host processor 502 from either local entry or remote entry originating at security management node 306. In a preferred embodiment, this relationship is defined by a symmetric encryption algorithm and an encryption key. In another embodiment, this relationship is defined by an asymmetric encryption algorithm and two keys. Comparison is performed by selecting one data set and converting it with an appropriate encryption algorithm and key. The result of this algorithm is then compared with the other data set. In a preferred embodiment; this comparison operation is performed by determining the arithmetic difference between the encryption algorithm result and the other data set. If this operation yields no difference, then the two data sets obtained by step 908 complement each other.

Step 916 acts on the comparison results obtained by step 912. If this comparison shows that the two data sets complement each other, then the article subject to verification is genuine and the verification process is complete. However, if this comparison does not show a complementary relationship, a counterfeit article has been detected. In this case, step 918 is performed next.

In step 918, verification node 304 issues a counterfeit detection report. In a preferred embodiment, this report is a audio visual alert to an operator of verification node 304. However, in an alternate embodiment, this report is a message sent from verification node 304 to security management node 306 across network 308.

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of creating a counterfeit resistant article, comprising the steps of:
reading a first pattern from an article;
encoding said first pattern into a first data set;
transforming said first data set into a second data set;
converting said second data set into a second pattern; and
marking an article with said second pattern

2. The method of claim 1, wherein said first and second data sets are numeric sequences.

3. The method of claim 1, wherein said transforming step is performed with an encryption algorithm.

4. The method of claim 1, wherein at least one of said first and second patterns is a bar code.

5. The method of claim 1, wherein at least one of said first and second patterns is invisible.

6. The method of claim 1, wherein at least one of said first and second patterns exists in the infra-red light spectrum.

7. A method of creating a counterfeit resistant article, comprising the steps of:
generating a plurality of complementary data sets;
converting said plurality of complementary data sets into a corresponding plurality of patterns; and
marking an article with said plurality of patterns.

8. The method of claim 7, wherein said plurality of complementary data sets are numeric sequences.

9. The method of claim 7, wherein said generating step is performed with an encryption algorithm.

10. The method of claim 7, wherein at least one of said plurality of patterns is a bar code.

11. The method of claim 7, wherein at least one of said plurality of patterns is invisible.

12. The method of claim 7, wherein at least one of said plurality of patterns exists in the infra-red light spectrum.

13. A method of identifying counterfeit articles, comprising the steps of:
reading a plurality of patterns;
converting said plurality of patterns into a corresponding plurality of data sets; and
comparing said plurality of data sets.

14. The method of claim 13, wherein said plurality of data sets are numeric sequences.

15. The method of claim 13, wherein said converting step is performed with an encryption algorithm.

16. The method of claim 13, wherein at least one of said plurality of patterns is a bar code.

17. The method of claim 13, wherein at least one of said plurality of patterns is invisible.

18. The method of claim 13, wherein at least one of said plurality of patterns exists in the infra-red light spectrum.

19. A system for creating a counterfeit resistant article, comprising:
means for reading a first pattern from an article;
means for encoding said first pattern into a first data set;
means for transforming said first data set into a second data set;
means for converting said second data set into a second pattern; and
means for marking an article with said second pattern.

20. The system of claim 19, wherein said first and second data sets are numeric sequences.

21. The system of claim 19, wherein said means for transforming comprises an encryption algorithm.

22. The system of claim 19, wherein at least one of said first and second patterns is a bar code.

23. The system of claim 19, wherein at least one of said first and second patterns is invisible.

24. The system of claim 19, wherein at least one of said first and second patterns exists in the infra-red light spectrum.

25. A system for creating a counterfeit resistant article, comprising:
means for generating a plurality of complementary data sets;
means for converting said plurality of complementary data sets into a corresponding plurality of patterns; and
means for marking an article with said plurality of patterns.

26. The system of claim 25, wherein said plurality of complementary data sets are numeric sequences.

27. The system of claim 25, wherein said means for generating is performed with an encryption algorithm.

28. The system of claim 25, wherein at least one of said plurality of patterns is a bar code.

29. The system of claim 25, wherein at least one of said plurality of patterns is invisible.

30. The system of claim 25, wherein at least one of said plurality of patterns exists in the infra-red light spectrum.

31. A system for identifying counterfeit articles, comprising:
means for reading a plurality of patterns;
means for converting said plurality of patterns into a corresponding plurality of data sets; and
means for comparing said plurality of data sets.

32. The system of claim 31, wherein said plurality of data sets are numeric sequences.

33. The system of claim 31, wherein said converting step is performed with an encryption algorithm.

34. The system of claim 31, wherein at least one of said plurality of patterns is a bar code.

35. The system of claim 31, wherein at least one of said plurality of patterns is invisible.

36. The system of claim 31, wherein at least one of said plurality of patterns exists in the infra-red light spectrum.

37. A counterfeit resistant article, comprising;
a first marking representing a first data set; and
a second marking representing a second data set, wherein said first data set and said second data set are related according to a defined relationship.

38. The counterfeit resistant article of claim 37, wherein said latent marking is invisible.

39. The counterfeit resistant article of claim 37, wherein said latent marking exists in the infrared light spectrum.

40. The counterfeit resistant article of claim 37, wherein said defined relationship is determined by an encryption algorithm and an encryption key.

41. The counterfeit resistant article of claim 37, further comprising a framing image.

42. A distributed counterfeit and prevention monitoring system, comprising:
a network;
a marking node connected to said network;
a verification node connected to said network; and
a security management node connected to said network.
